(19) United States
(12) Patent Application Publication
(10) Pub. No.: US 2026/0175229 A1
(43) Pub. Date: Jun. 25, 2026

(54) Reconfigurable Storage Rack And Method Of Use

(71) Applicants: Wei Song, Rochester, NY (US); Pinsu Wang, Panjin City (CN); Guangyao Wang, Shenyang (CN); Qian Song, Rochester, NY (US); Ning Kang, Rochester, NY (US); Fugui Wang, Panjin City (CN)

(72) Inventors: Wei Song, Rochester, NY (US); Pinsu Wang, Panjin City (CN); Guangyao Wang, Shenyang (CN); Qian Song, Rochester, NY (US); Ning Kang, Rochester, NY (US); Fugui Wang, Panjin City (CN)

(21) Appl. No.: 18/987,135

(22) Filed: Dec. 19, 2024

(51) Int. Cl. B01L 9/06

(52) U.S. Cl. CPC B01L 9/06; B01L 2200/022

(57) ABSTRACT

The present invention concerns a reconfigurable test tube storage rack assembly. Each assembly is in the form of six attachable panels which can be assembled in the form of a rectangular housing. Each of the panels have a unique array of receptacles for accommodating test tubes of various diameters. Once assembled, the user can rotate the assembly to select a panel with aperture sizes corresponding to the various sizes of a set of test tubes.

### BACKGROUND OF THE INVENTION

### Field of the Invention

The present invention relates to storage apparatuses. More particularly, it relates to a reconfigurable storage rack for test tubes.

### Description of the Prior Art

Test tubes, pipettes, and pipette tips are widely used in chemistry, biomedical and bioengineering testing for dispensing and transporting discrete amounts of a test liquid under sterile conditions. Since great numbers of pipette tips and tubes are typically used for certain experimental procedures, these tips and tubes are usually sold in racks. Racks may be rectangular trays having a matrix of receptacles or openings for receiving the tips or tubes. While it is known to provide racks with different size openings, the racks typically have a single surface or panel with multiple apertures. A user may then have to choose from several panels to find one with one or more openings of the proper size.

The racks may either be loaded manually, or by automated loaders which are capable of loading an entire rack at the same time. Different racks have different sized receptacles for receiving different diameter pipette tips and tubes.

In a laboratory environment, particularly in laboratories working with biologically active materials, it is important to have a secure means of supporting an array of test tubes, often in a predetermined order, and of transporting and storing them between uses. Among the desirable features in such a product are: transparency, so that the test tubes and their contents are readily visible; nestability, so that the parts of the test tube rack may be compactly nested when not in use; and stackability, so that assembled test tube racks may be stacked one on top of the other for storage. Also, storage racks have to have deep enough receptacle wells to secure the test tube which requires a structure beyond the panel through which the test tube or pipette is inserted.

The present invention concerns a reconfigurable test tube storage rack assembly. Each assembly is in the form of six attachable panels which can be assembled in the form of a rectangular housing. Each panel has a unique array of receptacles for accommodating test tubes of various diameters. Once assembled, the user can rotate the assembly to select a panel with aperture sizes corresponding to a set of test tubes.

### SUMMARY OF THE INVENTION

It is a major object of the invention to provide an improved storage rack.

It is another object of the invention to provide an improved storage rack for test tubes which is highly reconfigurable.

It is another object of the invention to provide an improved storage rack for test tubes capable of storing tubes of various diameters.

It is another object of the invention to provide an improved storage rack for test tubes where the body of the apparatus is formed of apertured panels sized for the insertion of test tubes.

These and other objects of the present invention will become readily apparent upon further review of the following specification and drawings.

The present invention meets or exceeds all the above objects and goals. Upon further study of the specification and appended claims, further objects and advantages of this invention will become apparent to those skilled in the art.

### BRIEF DESCRIPTION OF THE DRAWINGS

Various other objects, features, and attendant advantages of the present invention will become more fully appreciated as the same becomes better understood when considered with the accompanying drawings, in which like reference characters designate the same or similar parts throughout the several views, and wherein:

FIG. 1 shows a perspective view of the reconfigurable test tube rack of the invention.

FIG. 2 shows an exploded perspective view of the reconfigurable test tube rack of the invention.

FIG. 3 shows a perspective view of another reconfigurable test tube rack formed in accordance with the principles of the invention.

FIG. 4 shows a perspective view of two of the test tube racks illustrating how multiple racks can be added to accommodate multiple test tubes.

### DETAILED DESCRIPTION OF THE PREFERRED EMBODIMENTS

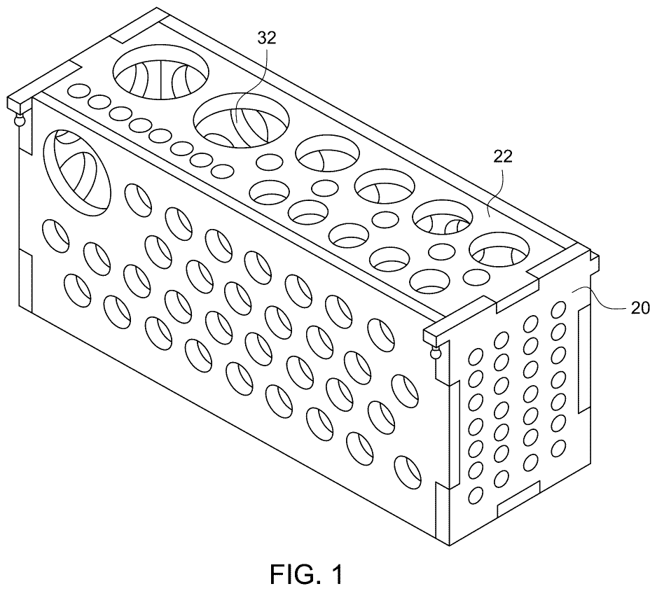

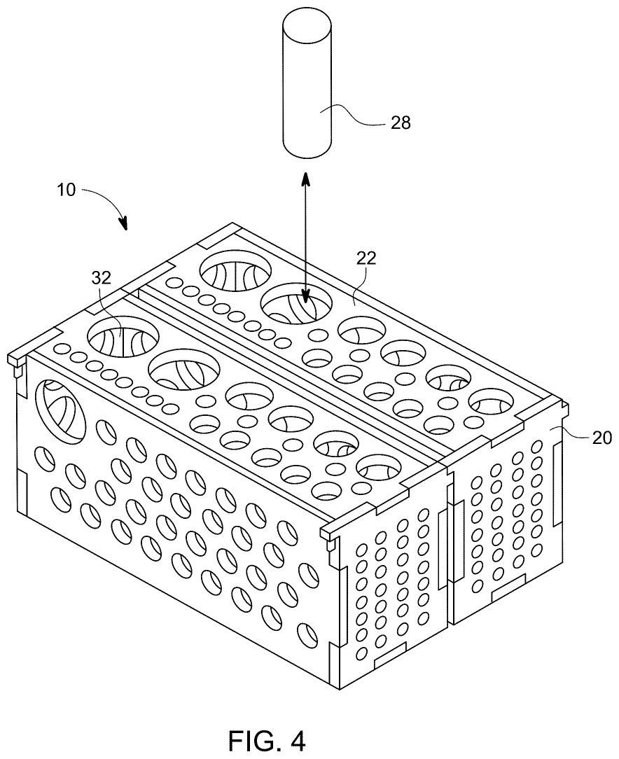

Referring now to FIGS. 1-4, the assembly of the present invention, generally indicated by the numeral 10, is shown. The assembly 10 is formed by a minimum of six apertured or receptacled panels, which may be end panels 20 or side panels 22. The panels 20, 22 essentially form the housing within which the test tubes 28 may be inserted. A key aspect of the invention is that the replaceable, exchangeable panels 20, 22 may be used to form a test tube rack having many different variations of diameters for the insertion of test tubes, pipettes, etc., with the rack re-orientable to position one of six differently configured, multiply apertured panels as the primary insertion panel 30. The insertion panel 20, 22 is the panel having a plane normal to the insertion direction (typically vertical) of the test tube 28 as seen most clearly in FIG. 4. A user can thus rotate the assembly housing to access one of six insertion panels 20, 22, which is then established as the insertion panel.

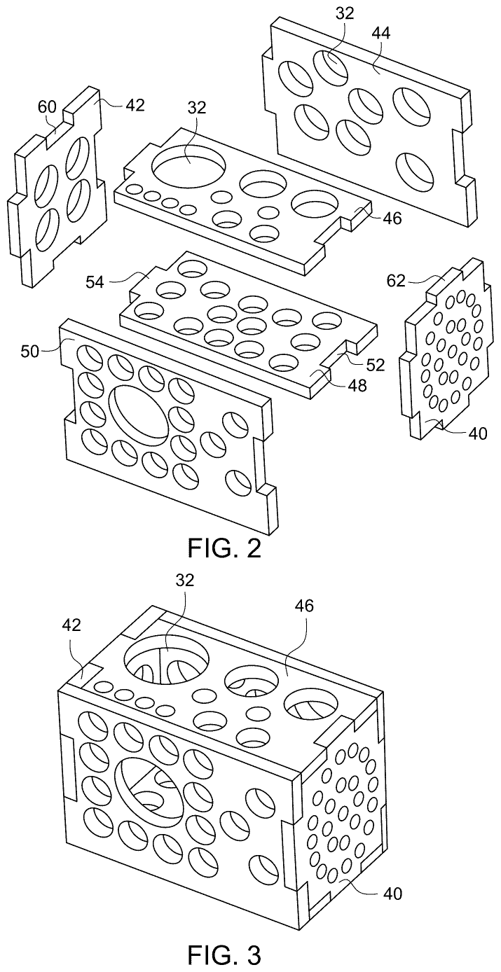

It can be seen that each panel 20, 22 can have a unique variation and array of aperture 32 sizes. For example, the insertion panel 22 shown in FIG. 1 can accommodate four different sizes of tubes 28 when oriented as shown in FIG. 1. The rack shown in FIG. 2 includes six panels 40, 42, 44, 46, 48, 50. Each panel has differently configured aperture sets and, when assembled, can be oriented to allow a user to access any of them. This gives the user great flexibility from a single set of six panels 40, 42, 44, 46, 48, 50, and the assembly 10 ensures that all six panels are available at once since they are literally attached together. Also, when in storage, the panels are literally attached to each other so that individual panels cannot be separated and lost.

The panels 20, 22 are all formed of a silicone material which has both flexibility and rigidity and the additional advantage that the surface is frictional or non-slip. Referring again to FIG. 1, it can be seen that all of the side panels 22 have female 52 and male 54 connecting edges. A first end panel 20 has female connecting edges 60 and the other end panel has male connecting edges 62. Panels 20, 22 are fitted together by inserting a male connecting edge 54, 62 within the notch of the female connecting edge 52, 60. Spring loaded snap fit connectors 70 are used to secure the connection, which may also be enhanced by magnets positioned at the edge of the panels 20, 22. If magnets are used, it enables stacking of the units 10 to allow for storage. It should be noted that magnets cannot be used in all cases, as a magnetic field can affect the contents of the test tubes.

The panels 20, 22, being relatively light weight can also be used as learning device for children. Children can be given tubes or cylinders to insert into apertures 32, allowing them to improve their spatial recognition skills as they try to assemble and orient different arrays of panels to accommodate the cylinders they are given. For example, a child may be given 10 tubes of various sizes, and must then assemble and orient the panels so that a panel having the right array of diameters can accommodate the given set of tubes.

From the foregoing description, one skilled in the art can easily ascertain the essential characteristics of this invention and, without departing from the spirit and scope thereof, can make various changes and modifications to adapt it to various usages and conditions.

It is to be understood that the present invention is not limited to the sole embodiment described above, but encompasses any and all embodiments within the scope of the following claims:

1. A reconfigurable test tube assembly comprising:
four side panels and two end panels, each of said panels having an array of apertures for the insertion of the test tubes;
connection means for connecting said side panels and end panels to form an enclosure;
whereby said enclosure may be rotated to establish an insertion panel parallel to a supporting surface.

2. The assembly of claim 1 wherein all of the apertures on each of said side panels have the same diameter.

3. The assembly of claim 1 wherein the apertures on at least one of said side panels are of differing diameters.

4. The assembly of claim 1 wherein all of the apertures on each of said end panels have the same diameter.

5. The assembly of claim 1 wherein the apertures on at least one of said end panels are of differing diameters.
